(19) United States
(12) Patent Application Publication
(10) Pub. No.: US 2024/0071123 A1
(43) Pub. Date: Feb. 29, 2024

(54) DETECTING HUMAN FACING DIRECTIONS USING THERMAL IMAGES FROM EMBEDDED OVERHEAD SENSORS

(71) Applicant: SIGNIFY HOLDING B.V., EINDHOVEN (NL)

(72) Inventors: JIN YU, LEXINGTON, MA (US); MARIANN ELIZABETH GREY SMITH, CAMBRIDGE, MA (US); BO SONG, PHILADELPHIA, PA (US)

(21) Appl. No.: 18/272,122

(22) PCT Filed: Dec. 24, 2021
(86) PCT No.: PCT/EP2021/087658

§ 371 Date: Jul. 13, 2023

Related U.S. Application Data
(60) Provisional application No. 63/136,939, filed on Jan. 13, 2021.

(30) Foreign Application Priority Data
Jan. 21, 2021 (EP) 21152771.8

(51) Int. Cl. G06V 40/10; G06T 7/70; G06V 10/14; G06V 10/22; G06V 10/26; G06V 10/762

(52) U.S. Cl. CPC G06V 40/10; G06T 7/70; G06V 10/14; G06V 10/22; G06V 10/26; G06V 10/762; G06T 2207/10048; G06T 2207/30201

(57) ABSTRACT

In accordance with example systems and methods, a data processing device can analyze the thermal images captured from an overhead thermal sensor to determine which of the thermal images exhibit a thermal pattern consistent with that of a human. The data processing device can determine a posture that is indicative of whether a person associated with the thermal image is sitting or standing, and can determine a directionality of the person based on the posture and an axis of a defined ellipse corresponding to the thermal image.

### TECHNICAL FIELD

The present application relates generally to the field of data processing, and more specifically to systems and methods relating detecting human facing directions using thermal images captured from overhead embedded sensors.

### BACKGROUND

Facing direction is information that can be applicable to a variety of situations. For example, in conference or meeting rooms and other areas, it can often be difficult to determine which direction a person is facing. Determining whether a person is facing a certain direction can be useful for a system that controls the illumination in that area. For example, once it is determined that persons in a conference room are facing a particular wall, which might have a screen illuminated by an overhead projector, or are facing a screen that is a large television display, or monitor display, then a lighting system might automatically adjust the ambient lighting of the room to accommodate that task. The lighting system can, for example, dim the lights in the room so that it would be easier for persons in the room to view the screen. Facing direction not only can help inform lighting control, but also help to understand the interaction between people, or be used for other applications, such as which shelf in a shopping store the customer is looking at, determining whether people are engaging in face-to-face discussions (which can be important to contact tracing) and determining whether people are complying with social distancing guidelines.

Chinese patent publication 110139449 discloses a particular illumination control solution using an infrared sensor and CMOS image sensor to provide thermal and light images for use with a pattern recognition algorithm to identify, from the images, the torso, limbs, and activity type of humans in the images. Moreover, the article “Action Segmentation and Recognition in Meeting Room Scenarios” by Frank Wallhoff, Martin Zobl, and Gerhard Rigoll published by IEEE from the 2004 International Conference on Singapore, in Piscataway, NJ, USA, vol. 4, pages 2223-2226 on Oct. 24, 2004 discloses using facial recognition technology and processing image sequences using neural network based facial recognition algorithms of a person's face in meeting scenarios to recognize or detect actions that could provide indication of an outcome of a meeting or how participants reacted during a meeting.

### BRIEF DESCRIPTION OF THE DRAWINGS

Non-limiting and non-exhaustive embodiments of the subject disclosure are described with reference to the following figures, wherein like reference numerals refer to like parts throughout the various views unless otherwise specified.

FIG. 1 is a diagram illustrating an example system for determining directionality using overhead thermal imagery, in accordance with various aspects and embodiments of the subject disclosure.

FIG. 2 is a flowchart illustrating an example process performed by a data processing device to determine directionality, in accordance with various aspects and embodiments of the subject disclosure.

FIG. 3 is another flowchart illustrating example operations performed by the data processing device to determine directionality, in accordance with various aspects and embodiments of the subject disclosure.

FIG. 4 illustrates different postures and the corresponding thermal image generated, in accordance with various aspects and embodiments of the subject disclosure.

FIG. 5 illustrates directionality corresponding to a major or minor axis, depending on posture, in accordance with various aspects and embodiments of the subject disclosure.

FIG. 6 depicts an example of various heat signatures of persons in a conference room, in accordance with various aspects and embodiments of the subject disclosure.

FIG. 7 illustrates an example block diagram of a computer that can be operable to execute processes and methods in accordance with various aspects and embodiments of the subject disclosure.

### DETAILED DESCRIPTION

The following description and the annexed drawings set forth in detail certain illustrative aspects of the subject matter. However, these aspects are indicative of but a few of the various ways in which the principles of the subject matter can be employed. Other aspects, advantages, and novel features of the disclosed subject matter will become apparent from the following detailed description when considered in conjunction with the provided drawings. In the following description, for purposes of explanation, numerous specific details are set forth in order to provide an understanding of the subject disclosure. It may be evident, however, that the subject disclosure can be practiced without these specific details. In other instances, well-known structures and devices are shown in block diagram form in order to facilitate describing the subject disclosure.

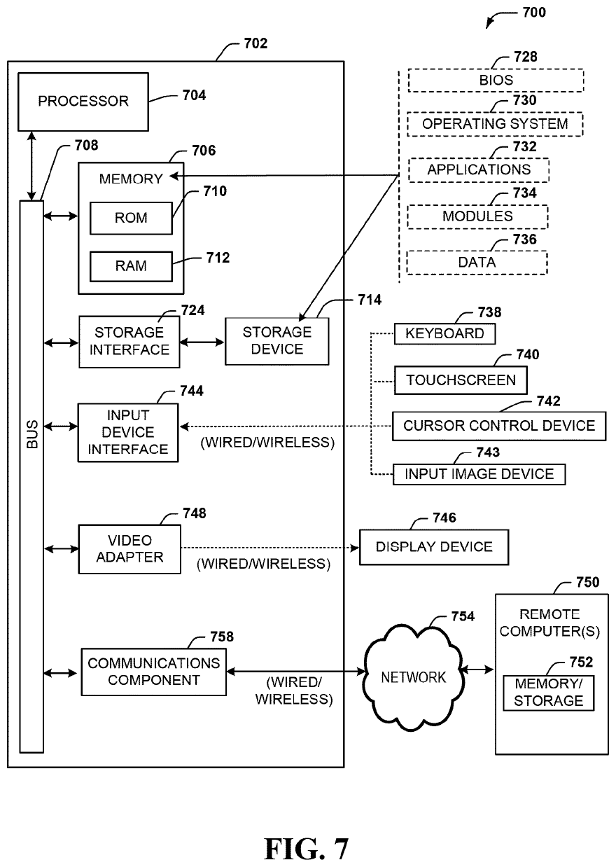

The subject disclosure of the present application describes example embodiments of systems (referred to herein as the “camera and light emission-based communication system,” or for convenience “example systems,” or “systems”) and methods, described below with reference to block diagrams and flowchart illustrations of methods, functions, apparatuses, and computer program products and modules. Steps of block diagrams and flowchart illustrations support combinations of mechanisms for performing the specified functions, combinations of steps for performing the specified functions, and program instructions for performing the specified functions. It should be understood that each step of the block diagrams and flowchart illustrations, combinations of steps in the block diagrams and flowchart illustrations, or any operations, functions, methods, and processes described herein, can be implemented, in accordance with example embodiments of the present invention, by computer processing systems comprising devices (e.g., camera, equipment, computer, mobile device, etc.), having one or more microprocessors and one or more memories that store executable instructions (e.g., computer program product, computer-readable instructions, software, software programs, software applications, etc.) that, when executed by the one or more microprocessors, facilitate (e.g., perform, control, command, direct, order, transmit signals enabling, etc.) performance of the operations, functions, methods, and processes described below in accordance with example embodiments of the present invention. The one or more microprocessors (e.g., processors, central processing unit (CPU), system on a chip (SoC), application specific integrated circuit (ASIC), combinations of these, or other programmable data processing apparatus) can be any microprocessor device known to those of ordinary skill, for example microprocessors offered for sale by Intel (e.g., branded Pentium microprocessors), Advanced Micro Devices (AMD), International Business Machines (IBM) and the like. It is also contemplated that microprocessors of other brands can be suitable. Additionally, future microprocessors, as they are developed and branded, are contemplated to be within the scope of the present invention. The term microprocessor is further elaborated upon below. The memories can comprise any suitable computer-readable storage medium, including, for example, on-chip memory, read only memory (ROM), random access memory (RAM), hard disks, compact disks, DVDs, optical data stores, and/or magnetic data stores. In addition to microprocessors and memories, the one or more devices can also comprise circuitry and hardware components as described below with respect to FIG. 7.

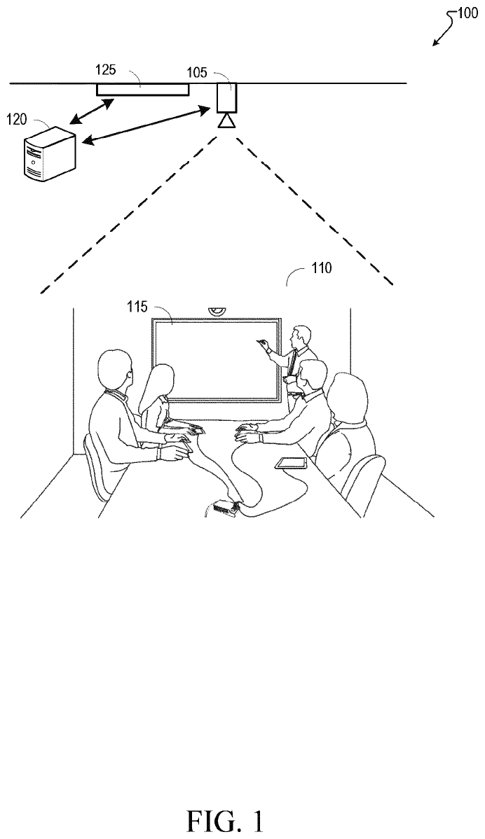

FIG. 1 is a diagram illustrating an example of an environment 100 depicting a system comprising one or more devices that can be used in the implementation of the present disclosure. The system can comprise an overhead thermal sensor 105 (or thermal sensor), which can be, for example, a thermopile array sensor. The overhead thermal sensor 105 can be placed above an area so as to be able to capture heat emanating from objects in the area. For example, the thermal sensor 105 can be placed above an area 110 (e.g., mounted on or near the ceiling), for example that of a conference room. The thermal sensor can be calibrated based on its location and a location of a detected person in the area 110. The area 110 might have a screen 115 to which persons in the room might from time to time direct their attention. The overhead thermal sensor 105 can capture thermopile images for the area, and the thermal images can be sent to and processed by a data processing device, e.g., data processing device 120. The data processing device 120 is operable to and can detect the posture of one or more persons in the area, and is operable to and can determine whether one or more persons in the area are likely facing a particular direction (e.g., determine directionality). Based on this information, the data processing device 120 can facilitate adjustment of the amount of light or intensity of light emanating, for example, from one or more luminaires 125, to which the data processing device 120 can be communicatively coupled (e.g., wired or wireless connection).

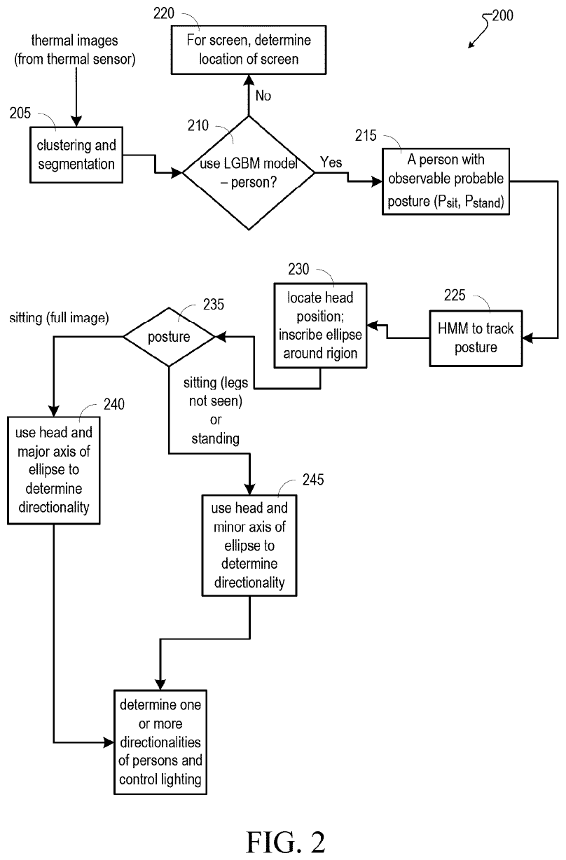

Referring now to FIG. 2, a flow diagram depicting an example process performed by a data processing device in accordance with the present application (e.g., data processing device 120), using machine learning, at block 205, the data processing device 120 can analyze received thermal images (sent by an overhead thermal sensor, e.g., overhead thermal sensor 105) determine heat sources, and cluster and segment out the heat sources (e.g., corresponding to individual persons). Then, the data processing device 120 can at block 210 use a machine learning model, for example, a Light Gradient Boosting Machine (LGBM) model, to determine whether a heat source is associated with heat generated by a human, and also detect posture of the segmented person (e.g., at block 215), the analysis of which can be based upon the probability of whether the person is sitting, sitting at a table or desk, or standing (e.g., Pₛᵢₜ and P_{stand}, wherein Pₛᵢₜ+P_{stand}=1.0). At 220, if the heat source is identified as, for example, a screen (e.g., video display), the system can record the location (e.g., coordinates, position, etc.) of the screen so that the location can later be used to determine whether persons are facing, or generally facing, the screen (alternatively, the screen location can be programmed into the system). At block 225, Additionally, the data processing device 120 can use a Hidden Markov Model to track the posture of the person. A Hidden Markov Model (HMM) can be used to track the posture using the observation probability (Pₛᵢₜ, P_{stand}) from the LGBM model and posture status transfer probability, assuming a person will not change posture very fast and frequently (like every second). In example embodiments it can be assumed a person's initial status is standing since a person usually walks (standing) into the area 7.

The data processing device can use signal processing to determine the directionality of the persons in the room (e.g., the probability that they are facing, for example a screen, or each other around a conference table). At block 230, this determination can employ a technique in which the image of a heat source can be analyzed to define or locate the head of a person, and define a region of the heat source, e.g., by drawing an inscribed ellipse, as explained in more detail below. Also, will be explained in more detail below, if at 235, based on the determination (e.g., at block 215), that a person is sitting, then at 240 the major axis of the defined ellipse can be used, along with the head location, to determine a facing direction, which can be based on a probability. If person is standing (or sitting with legs beneath a desk or table), then at 245 the minor axis of the ellipse, along with the head location, can be used to determine the facing direction.

The data processing device 120 can also employ the use of machine learning. As an example, it can label sensor data into four quadrants having known directions (e.g., knowing that is a person is sitting in the northeast quadrant, persons facing the screen would be facing in a generally eastward direction, whereas if two persons in the northeast quadrant were at a conference table, one would face east, while another person might face south or southwest). If persons were at a table, the data processing device 120 can use input of cluster features, detected head positions/postures to train a second LGBM model to learn the directionality.

Also, in example embodiments, in addition to or in lieu of a separate processing device 130, the thermal sensor can also comprise a microprocessor and memory having stored thereon machine readable (e.g., computer readable) instructions that allow it to perform the various functions described herein, can also process the images).

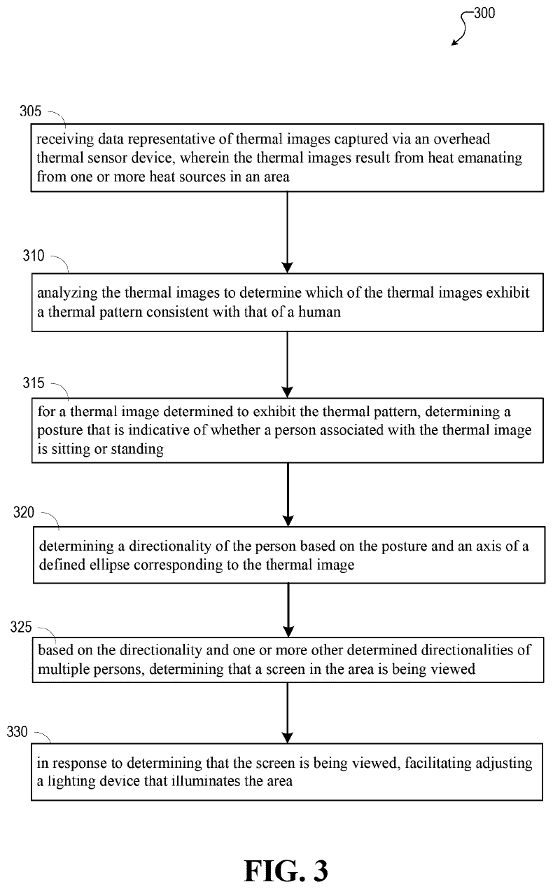

Referring now to FIG. 3, a data processing device (e.g., data processing device 120, or overhead thermal sensor 105) can comprise a microprocessor (examples of which device were described above) and a memory that stores executable instructions that, when executed by the microprocessor, facilitate performance of operations (e.g., methods) 300.

The operations 300 can at block 305 comprise receiving data representative of thermal images captured via an overhead thermal sensor device (e.g., overhead thermal sensor 105), wherein the thermal images result from heat emanating from one or more heat sources in an area. The heat sources might be from one or more persons, and might also be from a screen (e.g., an electronic display such as a television or large computer monitor, etc.).

At block 310, the operations 300 can comprise analyzing the thermal images to determine which of the thermal images exhibit a thermal pattern consistent with that of a human. The process can use, for example, a Light Gradient Boosting Machine (LGBM) model. Thermal image of a device such as an electronic screen, which generates heat, might have not only a different shape from a human (e.g., more rectangular), but might also have a different temperature, represented by a different shade of color (e.g., a television might not emanate a temperature shown to be hotter than a human head). Analyzing the thermal images can also comprise using a clustering technique, and a segmentation technique, which are known statistical methods. From this, it is possible to determine that different regions of a thermal image represent heat emanating from a television versus a human.

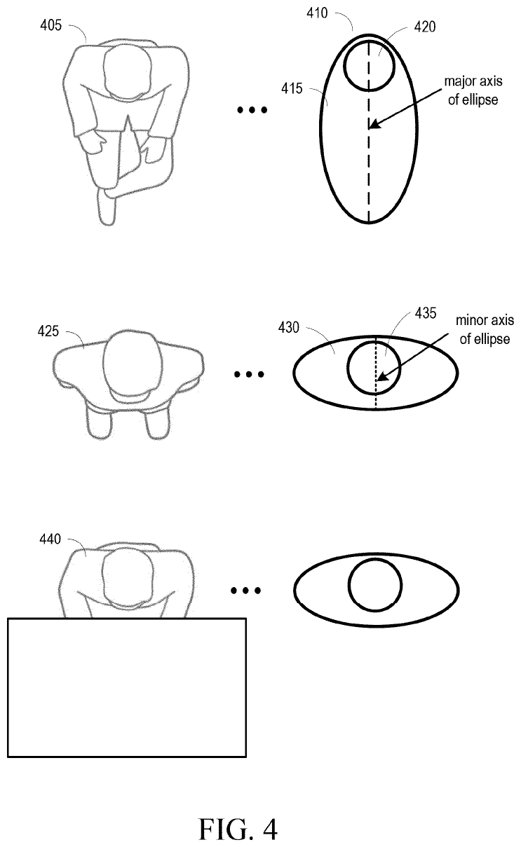

At block 315, the operations 300 can comprise, for a thermal image determined to exhibit the thermal pattern of a person (e.g., human), determining a posture that is indicative of whether a person associated with the thermal image is sitting or standing. The posture can be determined, for example, using a clustering technique. Referring now to FIG. 4, determining the posture can comprise determining a first thermal region defined by a perimeter, and determining a second thermal region. In the case of a human, the first thermal region can be a thermal region associated with the body of a person, which would be an elliptical-shaped pattern, and the second thermal region would be the head of a person, the pattern of which would be more in the shape of a circle. A sitting person 405 generates a thermal image that bears a pattern similar to sitting pattern 410, wherein the data processing device 120 can determine a location of a first thermal region corresponding to the body of the person 415, which thermographic region would appear in a different color (e.g., a shade of blue) versus a second thermal region 420 corresponding to the head of the person (e.g., a shade of red) to represent the difference in temperature of heat generated by the head versus the rest of the body. As can be seen, the head region 420 is close to one end of the elliptical region 415 defining the body. Thus, the data processing device 120, in response to determining that the second thermal region (e.g., head region) is in proximity to an end of a major axis of the perimeter of the ellipse (415), determines that the person is sitting.

Still referring to FIG. 4, for a standing person 425, the elliptical region representing the body is shown as 430, and the circular region representing the head is shown as 435. Here, the circular region 435 is closer to the center of the elliptical region 430. The data processing device 120, can, in response to determining that the head region is closer to the center of the body elliptical region 430, determine that the person is in a standing posture. Alternatively, or additionally, the data processing device 120 can determine that the second thermal region is in proximity to an end of a minor axis of the elliptical perimeter, which can also lead to the determination that the person is sitting. Still referring to FIG. 4, a person sitting with legs hidden under a table 440 has a posture similar to when they stand, because the heat generated from the legs may not be picked up by the thermal sensor on account of being blocked by the desk or table. A reduced cluster area can indicate this is the case.

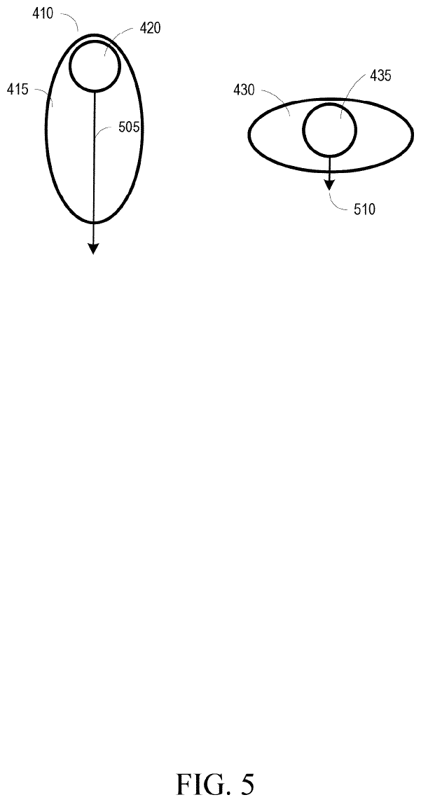

Referring back to FIG. 3, at block 320, the operations performed by the data processing device can comprise determining a directionality of the person (e.g., which way a person is facing) based on the posture and an axis of a defined ellipse corresponding to the thermal image. As shown in FIG. 5, determining the directionality (arrow 505) can be based on the posture of the person and a direction in line with the minor axis of the perimeter, in the case of a sitting person 405. In the case of a standing person 425 or a person sitting with legs underneath a table or desk 440, determining the directionality (arrow 510) can be based on the posture of the person and a direction in line with the minor axis of the elliptical perimeter. In this situation, using the minor axis as the facing direction takes into account whether the person's legs are beneath a table or desk.

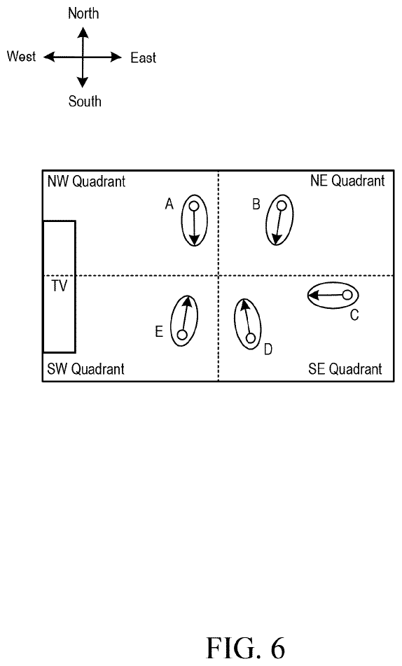

Referring back to FIG. 3. the operations 300 can comprise, at block 325, based on the directionality and one or more other determined directionalities of multiple persons, determining that a screen in the area is being viewed. Now referring to FIG. 6, machine learning can be employed to utilize information discussed above (e.g., posture, location of screen, etc.) derived from analysis one of more of the analysis thermal images. As an example, the data processing device 120 can label sensor data into four quadrants having known directions, and utilize the posture and directionality to determine whether people are facing a screen. For example, referring for the moment to FIG. 6, determining that a person is sitting in the northeast quadrant, persons B and C in the northeast quadrant facing the screen would be facing in a generally eastward direction (e.g., toward the screen), whereas if persons B and C were at a conference table, C would face east, while B might face south or southwest). Additionally, while each axis (minor or major) can have two directions in line with the axis, an analysis of the directionality of persons A, B, C, D and E would indicate that it is more likely that they are facing each other, at a conference table, then having their backs turned to one another facing in a direction away from the conference table. Other nuances that can impact the probability might be slouching or leaning forward, but a determination can be based on probability (e.g., 80%). The data processing device 120 can thus use inputs of cluster features, detected head positions and postures to train a second LGBM model to learn the directionality.

Referring back to FIG. 3, the operations 300 can at block 330, further comprise, in response to determining that the screen is being viewed, facilitating adjusting a lighting device that illuminates the area. This can comprise, for example, sending a command to one or more luminaires (e.g., one or more luminaires 125) to dim, or to shut off certain light sources (e.g., light emitting diodes (LEDs) of the luminaire.

FIG. 7 schematically shows an example implementation of a computing system 700. In example implementations, various devices used in the systems described above and belong in the claims (e.g., the data processing device 120, overhead thermal sensor 105), in accordance with this disclosure, can comprise one or more components as described in FIG. 7. The computing system 700 can include a computer 702. Computer 702 can comprise a microprocessor 704, memory 706, various interfaces, and various adapters, each of which can be coupled via a local interface, such as system bus 708. The system bus 708 can be any of several types of bus structures that can interconnect to a memory bus (with or without a memory controller), a peripheral bus, and a local bus using any of a variety of commercially available bus architectures.

The microprocessor 704 is capable of processing computer-executable instructions that, when executed by the microprocessor 704, facilitate performance of operations, including methods, operations, functions, or steps described in this disclosure. The microprocessor 704 can comprise one of more devices that can process the instructions. The computer-executable instructions can comprise a program file, software, software module, program module, software application, etc., that is in a form that can ultimately be run by the microprocessor 704. The computer-executable instructions can be, for example: a compiled program that can be translated into machine code in a format that can be loaded into a random access memory 712 of memory 706 and run by the microprocessor 704; source code that may be expressed in proper format such as object code that is capable of being loaded into a random access memory 712 and executed by the microprocessor 704; or source code that may be interpreted by another executable program to generate instructions in a random access memory 712 to be executed by the microprocessor 704, etc. Although the software applications as described herein may be embodied in software or code executed by hardware as discussed in FIG. 7, as an alternative the same may also be embodied in dedicated hardware or a combination of software/general purpose hardware and dedicated hardware.

The computer-executable instructions can be stored on a machine-readable storage media (i.e., computer-readable storage media, also referred to as machine-readable storage medium, or as computer-readable storage medium). The computer-readable storage media can comprise memory 706, as well as storage device 714. The memory 706 can represent multiple memories that operate in parallel processing circuits, and memory 706 can comprise both nonvolatile memory (e.g., read-only memory (ROM)) and volatile memory (e.g., random access memory (RAM)), illustrated by way of example as ROM 710 and RAM 712.

The computer 702 can further comprise a storage device 714 (or additional storage devices) that can store data or software program modules. Storage device 714 can comprise, for example, an internal hard disk drive (HDD) (e.g., EIDE, SATA), solid state drive (SSD), one or more external storage devices (e.g., a magnetic floppy disk drive (FDD), a memory stick or flash drive reader, a memory card reader, etc.), an optical disk drive 720 (e.g., which can read or write from a compact disc (CD), a digital versatile disk (DVD), a BluRay Disc (BD), etc.). While storage device 714 is illustrated as located within the computer 702, the storage device 714 can also be of the variety configured for external, or peripheral, location and use (e.g., external to the housing of the computer 702). The storage device can be connected to the system bus 708 by storage interface 724, which can be an HDD interface, an external storage interface, an optical drive interface, a Universal Serial Bus (USB) interface, and any other internal or external drive interfaces.

ROM 710, and also storage device 714, can provide nonvolatile storage of data, data structures, databases, software program modules (e.g., computer-executable instructions), etc., which can be, for example, a basic input/output system (BIOS) 728, an operating system 730, one or more application programs 732, other program modules 734, and application program data 736. Where any component discussed herein is implemented in the form of software, any one of a number of programming languages can be employed, such as, for example, C, C++, C#, Objective C, Java®, JavaScript®, Perl, PHP, Visual Basic®, Python®, Ruby, Flash®, or other programming languages. Data can be stored in a suitable digital format. All or portions of the operating system, applications, modules, or data can also be cached in the RAM 712. The microprocessor 704 can also comprise on-chip memory to facilitate processing of the instructions. The systems and methods described herein can be implemented utilizing various commercially available operating systems or combinations of operating systems. Although the description of computer-readable storage media above refers to respective types of storage devices, it should be appreciated by those skilled in the art that other types of storage media which are readable by a computer, whether presently existing or developed in the future, could also be used in the example operating environment.

Computer 702 can optionally comprise emulation technologies. For example, a hypervisor (not shown) or other intermediary can emulate a hardware environment for operating system 730, and the emulated hardware can optionally be different from the hardware illustrated in FIG. 7. In such an embodiment, operating system 730 can comprise one virtual machine (VM) of multiple VMs hosted at computer 702. Furthermore, operating system 730 can provide runtime environments, such as the Java runtime environment or the .NET framework, for applications 732. Runtime environments are consistent execution environments that allow applications 732 to run on any operating system that includes the runtime environment. Similarly, operating system 730 can support containers, and applications 732 can be in the form of containers, which are lightweight, standalone, executable packages of software that include, e.g., code, runtime, system tools, system libraries and settings for an application.

Further, computer 702 can be enable with a security module, such as a trusted processing module (TPM). For instance, with a TPM, boot components hash next in time boot components, and wait for a match of results to secured values, before loading a next boot component. This process can take place at any layer in the code execution stack of computer 702, e.g., applied at the application execution level or at the operating system (OS) kernel level, thereby enabling security at any level of code execution.

To the extent that certain user inputs are desirable (as indicated by the dotted line), a user can enter commands and information into the computer 702 using one or more wired/wireless input devices, such as a keyboard 738, a touch screen 740, or a cursor control device 742 (such as a mouse, touchpad, or trackball), or an image input device (e.g., camera(s)) 743. Other input devices (not shown) can comprise a microphone, an infrared (IR) remote control, a radio frequency (RF) remote control, or other remote control, a joystick, control pad, a virtual reality controller and/or virtual reality headset, a game pad, a stylus pen, a gesture sensor input device, a vision movement sensor input device, an emotion or facial detection device, a biometric input device, (e.g., fingerprint or iris scanner), or the like. These and other input devices are often connected to the processing unit 704 through an input device interface 744 that can be coupled to the system bus 708, but can be connected by other interfaces, such as a parallel port, a game port, a USB port, audio port, an IR interface, a BLUETOOTH® interface, etc.

To the extent desired (as noted by the dotted line), a display device 746, such as a monitor, television, or other type of display device, can be also connected to the system bus 708 via an interface, such as a video adapter 748. In addition to the display device 746, a computer 702 can also connect with other output devices (not shown), such as speakers, printers, etc.

The computer 702 can operate in a networked environment using wired or wireless communications to one or more remote computers, such as a remote computer 750 (e.g., one or more remote computers). The remote computer 750 can be a workstation, a server computer, a router, a personal computer, a tablet, a cellular phone, a portable computer, microprocessor-based entertainment appliance, a peer device, a network node, and internet of things (IoT) device, and the like, and typically includes many or all of the elements described relative to the computer 702, although, for purposes of brevity, only a memory/storage device 752 is illustrated. When used in a networked environment, the computer 702 can access cloud storage systems or other network-based storage systems in addition to, or in place of, external storage devices 714 as described above. For example, as part of the cloud storage or network-based storage system, a remote computer 750 can comprise a computing device that is primarily used for storage, such as a network attached storage device (NAS), redundant array of disks (RADs), or a device that is a part of a SAN (storage area network), wherein the storage device comprises memory/storage 752. In a networked environment, program modules depicted relative to the computer 702 or portions thereof, can be stored in the remote memory/storage device 752 (some refer to this as “cloud storage” or “storage in the cloud). Likewise, data and information, including data associated with applications or program modules, can also be stored remotely at the remote memory/storage device 752. A remote computer 750 that is a server device can facilitate storage and retrieval of information to a networked memory/storage device 752. Upon connecting the computer 702 to an associated cloud storage system, the computer 702 can manage storage provided by the cloud storage system as it would other types of external storage. For instance, access to cloud storage sources can be provided as if those sources were stored locally on the computer 702.

Generally, a connection between the computer 702 and a cloud storage system can be established, either via wired or wireless connectivity, over a network 754. The network can be, for example, wireless fidelity (Wi-Fi) network, a local area network (LAN), wireless LAN, larger networks (e.g., a wide area network (WAN)), cable-based communication network (e.g., a communication network implementing the data over cable service interface specification (DOCSIS), asynchronous transfer mode (ATM) network, digital subscriber line (DSL) network, asymmetric digital subscriber line (ADSL) network, a cellular network (e.g., 4G Long Term Evolution (LTE), 5G, etc.), and other typical fixed and mobile broadband communications networks, and can comprise components (e.g., headend equipment, local serving office equipment, Digital Subscriber Line Access Multiplexers (DSLAMs), Cable Modem Termination Systems (CMTSs), cellular nodes, etc.) related to each of these types of networks. The network 754 can facilitate connections to a global communications network (e.g., the Internet).

When used in a networking environment, the computer 702 can be connected to the network 754 through a wired or wireless communications component 758. The communications component 758 can comprise, for example, a network work interface adapter (e.g., network interface card), wireless access point (WAP) adapter. The communications component 758 can also comprise cellular receivers, cellular transmitters, and cellular transceivers that enable cellular communications. The communications component 758 can facilitate wired or wireless communication to the network 754, which can include facilitating communications through a gateway device, such as a cable modem, DSL modem, ADSL modem, cable telephony modem, wireless router, or other devices that can be used to facilitate establishment of communications. The gateway device, which can be internal or external and a wired or wireless device, can be connected to the system bus 708 via the communications component 758. It will be appreciated that the network connections and components shown are examples, and other methods of establishing a communications link between a remote computer 750 can be used.

As used in this application, the terms “system,” “component,” “interface,” and the like are generally intended to refer to a computer-related entity or an entity related to an operational machine with one or more specific functionalities. The entities disclosed herein can be either hardware, a combination of hardware and software, software, or software in execution. For example, a component can be, but is not limited to being, a process running on a microprocessor, a microprocessor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. These components also can execute from various computer readable storage media comprising various data structures stored thereon. The components can communicate via local and/or remote processes such as in accordance with a signal comprising one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry that is operated by software or firmware application(s) executed by a microprocessor, wherein the microprocessor can be internal or external to the apparatus and executes at least a part of the software or firmware application. As yet another example, a component can be an apparatus that provides specific functionality through electronic components without mechanical parts, the electronic components can comprise a microprocessor therein to execute software or firmware that confers at least in part the functionality of the electronic components. An interface can comprise input/output (I/O) components as well as associated microprocessor, application, and/or API components.

As it is used in the subject specification, the term “microprocessor” can refer to substantially any computing processing unit or device comprising single-core microprocessors; single-microprocessors with software multithread execution capability; multi-core microprocessors; multi-core microprocessors with software multithread execution capability; multi-core microprocessors with hardware multithread technology; parallel platforms; and parallel platforms with distributed shared memory. Additionally, a microprocessor can refer to an integrated circuit, a central processing unit (CPU), an application specific integrated circuit (ASIC), a digital signal microprocessor (DSP), a field programmable gate array (FPGA), a programmable logic controller (PLC), a complex programmable logic device (CPLD), a discrete gate or transistor logic, discrete hardware components, or any combination thereof designed to perform the functions described herein. Microprocessors can exploit nano-scale architectures such as, but not limited to, molecular and quantum-dot based transistors, switches and gates, in order to optimize space usage or enhance performance of UE. A microprocessor also can be implemented as a combination of computing processing units.

Furthermore, the disclosed subject matter can be implemented as a method, apparatus, or article of manufacture using standard programming and/or engineering techniques to produce software, firmware, hardware, or any combination thereof to control a computer to implement the disclosed subject matter.

The term “article of manufacture” as used herein is intended to encompass any computer-readable device, computer-readable carrier, or computer-readable storage media having stored thereon computer-executable instructions. Computing devices typically comprise a variety of media, which can comprise computer-readable storage media, which can be implemented in connection with any method or technology for storage of information such as computer-readable instructions, program modules, structured data, or unstructured data. Computer-readable storage media can be any available storage media that can be accessed by the computer, and can comprise various forms of memory, as will be elaborated further below.

In the subject specification, terms such as “store,” “data store,” “data storage,” “database,” “repository,” “queue”, and substantially any other information storage component relevant to operation and functionality of a component, refer to “memory components,” or entities embodied in a “memory” or components comprising the memory. Memory can be of various types, such as hard-disk drives (HDD), floppy disks, zip disks, magnetic cassettes, magnetic tape, magnetic disk storage or other magnetic storage devices, flash memory devices (cards, sticks, key drives, thumb drives), cartridges, optical discs (e.g., compact discs (CD), digital versatile disk (DVD), Blu-ray Disc (BD)), a virtual device that emulates a storage device, and other tangible and/or non-transitory media which can be used to store desired information. It will be appreciated that the memory components or memory elements described herein can be removable or stationary. Moreover, memory can be internal or external to a device or component. Memory can also comprise volatile memory as well as nonvolatile memory, whereby volatile memory components are those that do not retain data values upon loss of power and nonvolatile components are those that retain data upon a loss of power.

By way of illustration, and not limitation, nonvolatile memory can comprise read only memory (ROM), programmable ROM (PROM), erasable programmable ROM (EPROM), electrically erasable programmable ROM (EEPROM), or flash memory. Volatile memory can comprise random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), magnetic random access memory (MRAM), and direct Rambus RAM (DRRAM). Additionally, the disclosed memory components of systems or methods herein are intended to comprise these and any other suitable types of memory.

The term “facilitate” as used herein is in the context of a system, device or component “facilitating” one or more actions, methods, or example operations, in respect of the nature of complex computing environments in which multiple components and/or multiple devices can be involved in some computing operations. Non-limiting examples of actions that may or may not involve multiple components and/or multiple devices comprise the methods described herein, including but not limited to transmitting or receiving data, establishing a connection between devices, determining intermediate results toward obtaining a result, etc. In this regard, a computing device or component can facilitate an operation by playing any part in accomplishing the operation (e.g., directing, controlling, enabling, etc.). When operations of a component are described herein, it is thus to be understood that where the operations are described as facilitated by the component, the operations can be optionally completed with the cooperation of one or more other computing devices or components, such as, but not limited to, microprocessors, application specific integrated circuits (ASICs), sensors, antennae, audio and/or visual output devices, other devices, etc.

In particular and in regard to the various functions performed by the above described components, devices, circuits, systems and the like, the terms (comprising a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated example aspects of the embodiments. In this regard, it will also be recognized that the embodiments comprise a system as well as a computer-readable storage media comprising computer-executable instructions for performing the acts or events of the various methods. Additionally, unless claim language specifically recites “means for”, the claim is intended to encompass a recited claim structure, and not invoke means plus function language.

Furthermore, the terms “user,” “subscriber,” “customer,” “consumer,” and the like are employed interchangeably throughout the subject specification, unless context warrants particular distinction(s) among the terms. It should be appreciated that such terms can refer to human entities, associated devices, or automated components supported through artificial intelligence (e.g., a capacity to make inference based on complex mathematical formalisms) which can provide simulated vision, sound recognition and so forth. In addition, the terms “wireless network” and “network” are used interchangeably in the present application, when context wherein the term is utilized warrants distinction for clarity purposes such distinction is made explicit.

Moreover, the word “exemplary,” where used, is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. Wherever the phrases “for example,” “such as,” “including” and the like are used herein, the phrase “and without limitation” is understood to follow unless explicitly stated otherwise.

As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

Furthermore, references to singular components or items are intended, unless otherwise specified, to encompass two or more such components or items. For example, the articles “a” and “an” as used in this application and the appended claims should generally be construed to mean “one or more” unless specified otherwise or clear from context to be directed to a singular form.

The term “about” is meant to account for variations due to experimental error. All measurements or numbers are implicitly understood to be modified by the word about, even if the measurement or number is not explicitly modified by the word about.

The term “substantially” (or alternatively “effectively”) is meant to permit deviations from the descriptive term that do not negatively impact the intended purpose. Descriptive terms are implicitly understood to be modified by the word substantially, even if the term is not explicitly modified by the word “substantially.”

In addition, while a particular feature may have been disclosed with respect to only one of several implementations, such feature can be combined with one or more other features of the other implementations as may be desired and advantageous for any given or particular application. To the extent that the terms “has,” “have”, “having”, “comprising” and “including” and “involving” and variants thereof (e.g., “comprises,” “includes,” and “involves”) are used interchangeably and mean the same thing—these terms are defined consistent with the common patent law definition of “comprising” and is therefore interpreted to be an open term meaning “at least the following but is not limited to,” and as such is not to be interpreted to exclude additional features, limitations, aspects, etc.

The above descriptions of various example embodiments and example implementations of the subject disclosure, corresponding figures, and what is described in the Abstract, are described herein for illustrative purposes, and are not intended to be exhaustive or to limit the disclosed embodiments to the precise forms disclosed. It is to be understood that one of ordinary skill in the art can recognize that other embodiments comprising modifications, permutations, combinations, and additions can be implemented for performing the same, similar, alternative, or substitute functions of the disclosed subject matter, and are therefore considered within the scope of this disclosure.

For example, disclosed systems and apparatuses and components or subsets thereof (referred to hereinafter as components) should neither be presumed to be exclusive of other disclosed systems and apparatuses, nor should an apparatus be presumed to be exclusive to its depicted components in an example embodiment or embodiments of this disclosure, unless where clear from context to the contrary. Additionally, steps or blocks as shown in example methods, or operations, can be interchangeable with steps or blocks as show in other example methods or operations. The scope of the disclosure is generally intended to encompass modifications of depicted embodiments with additions from other depicted embodiments, where suitable, interoperability among or between depicted embodiments, where suitable, as well as addition of a component(s) from one embodiment(s) within another or subtraction of a component(s) from any depicted embodiment, where suitable, aggregation of components (or embodiments) into a single component achieving aggregate functionality, where suitable, or distribution of functionality of a single system or component into multiple systems or components, where suitable. In addition, incorporation, combination or modification of systems or components depicted herein or modified as stated above with systems, apparatuses, components or subsets thereof not explicitly depicted herein but known in the art or made evident to one with ordinary skill in the art through the context disclosed herein are also considered within the scope of the present disclosure. As such, although a particular feature of the present invention may have been illustrated or described with respect to only one of several implementations, any such feature may be combined with one or more other features of the other implementations as may be desired and advantageous for any given or particular application.

Therefore, the disclosed subject matter should not be limited to any single embodiment described herein, but rather should be construed in breadth and scope in accordance with the claims, including all equivalents, that are listed below.

1. A data processing device, comprising:
a microprocessor; and
a memory that stores executable instructions that, when executed by the microprocessor, facilitate performance of operations, comprising:
receiving data representative of thermal images captured via an overhead thermal sensor, wherein the thermal images result from heat emanating from one or more heat sources in an area;
analyzing the thermal images to determine which of the thermal images exhibit a thermal pattern consistent with that of a human, wherein the analyzing of the thermal images includes creating a defined elongated shape associated with a thermal profile of a body of the human and a defined circular shape associated with a thermal profile of a head of the human;
for a thermal image determined to exhibit the thermal pattern, determining a posture indicative of whether a person associated with the thermal image is sitting or standing based on an orientation of the defined elongated shape in association with the circular shape, determining a first thermal region defined by a perimeter, determining a second thermal region, and determining whether the person is sitting or standing based on a position of the second thermal region with respect to the first thermal region; and
when the posture is determined to be standing, determining a directionality of the person based a minor axis of the defined elongated shape corresponding to the thermal image,
wherein, in response to determining that the second thermal region is centered with respect to the first thermal region and that the perimeter of the first thermal region is elliptical shaped, determining that the person is standing, and
wherein in response to determining that the second thermal region is in proximity to an end of a major axis of the perimeter and that the perimeter is elliptical, shaped, determining that the person is sitting.

2. The data processing device of claim 1, wherein analyzing the thermal images comprises using a segmentation technique.

3. The data processing device of claim 1, wherein determining the posture comprises using a clustering technique.

4. (canceled)

5. (canceled)

6. (canceled)

7. (canceled)

8. The data processing device of claim 1, wherein determining the directionality comprises:
determining the directionality based on the posture of the person and a direction in line with the major axis of the perimeter.

9. The data processing device of claim 1, wherein the operations further comprise:
based on the directionality and one or more other determined directionalities of multiple persons, determining that a screen in the area is being viewed; and
in response to determining that the screen is being viewed, facilitating adjusting a lighting device that illuminates the area.

10. A data processing method performed by a device comprising a microprocessor and a memory, the method comprising:
receiving data representative of thermal images captured via an overhead thermal sensor device, wherein the thermal images result from heat emanating from one or more heat sources in an area;
analyzing the thermal images to determine which of the thermal images exhibit a thermal pattern consistent with that of a human;
for a thermal image determined to exhibit the thermal pattern, determining a posture that is indicative of whether a person associated with the thermal image is sitting or standing, determining a first thermal region defined by a perimeter, determining a second thermal region, and determining whether the person is sitting or standing based on a position of the second thermal region with respect to the first thermal region;
determining a directionality of the person based on the posture and an axis of a defined ellipse corresponding to the thermal image;
based on the directionality and one or more other determined directionalities of multiple persons, determining that a screen in the area is being viewed; and
in response to determining that the screen is being viewed, facilitating adjusting a lighting device that illuminates the area,
wherein, in response to determining that the second thermal region is centered with respect to the first thermal region and that the perimeter of the first thermal region is elliptical shaped, determining that the person is standing, and
wherein, in response to determining that the second thermal region is in proximity to an end of a major axis of the perimeter and that the perimeter is elliptical shaped, determining that the person is sitting.

11. A machine-readable storage medium, comprising executable instructions that, when executed by a processor inside a wireless communication module, facilitate performance of operations, comprising:
receiving data representative of thermal images captured via an overhead thermal sensor device, wherein the thermal images result from heat emanating from one or more heat sources in an area;
analyzing the thermal images to determine which of the thermal images exhibit a thermal pattern consistent with that of a human;
for a thermal image determined to exhibit the thermal pattern, determining using a light gradient boosting model, a posture that is indicative of whether a person associated with the thermal image is sitting or standing, determining a first thermal region defined by a perimeter, determining a second thermal region, and determining whether the person is sitting or standing based on a position of the second thermal region with respect to the first thermal region;
determining a directionality of the person based on the posture and an axis of a defined ellipse corresponding to the thermal image;
based on the directionality and one or more other determined directionalities of multiple persons, determining that a screen in the area is being viewed; and
in response to determining that the screen is being viewed, facilitating adjusting a lighting device that illuminates the area,
wherein, in response to determining that the second thermal region is centered with respect to the first thermal region and that the perimeter of the first thermal region is elliptical shaped, determining that the person is standing, and
wherein, in response to determining that the second thermal region is in proximity to an end of a major axis of the perimeter and that the perimeter is elliptical shaped, determining that the person is sitting.

12. The machine-readable storage medium of claim 10, wherein determining a posture that is indicative of whether the person associated with the thermal image is sitting or standing further comprises determining a location of a region corresponding to the head of the person.

13. The machine-readable storage medium of claim 10, wherein determining the directionality of the person further comprises taking into account whether the person's legs are beneath a table.

14. The data processing device of claim 1, wherein the microprocessor executing the operation of:
when the posture is determined to be sitting, determining a directionality of the person based on a major axis of the defined elongated shape corresponding to the thermal image.

15. The data processing device of claim 1, wherein the elongated shape is an ellipse.
